(19) United States
(12) Patent Application Publication
(10) Pub. No.: US 2006/0207354 A1
(43) Pub. Date: Sep. 21, 2006

(54) Apparatus for testing liquid crystal display panels

(75) Inventor: Zhi-Gang Zhao, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/384,626

(22) Filed: Mar. 20, 2006

(30) Foreign Application Priority Data
Mar. 18, 2005 (TW) 94204239

(51) Int. Cl. G01N 19/00

(52) U.S. Cl. 73/865.9

(57) ABSTRACT

An exemplary apparatus (20) for testing liquid crystal display panels includes an angle adjusting device (21) and a supporting plate (22) mounted on the angle adjusting device for supporting at least one liquid crystal display panel. The angle adjusting device includes a base (211) and a ball-and-socket joint (213) mounted on the base. The ball-and-socket joint includes a rocker (2131) with a spherical end, a first connecting rod (2132) with a groove (2134) and a second connecting rod (2133) with a complementary groove. The grooves of the first and second connecting rods cooperatively define a socket for containing the spherical end of the rocker therein. The first connecting rod is movable relative to the second connecting rod so that the spherical end of the rocker is either locked in a desired position or frees to be manually rotated to a desired position.

### FIELD OF THE INVENTION

The present invention relates to an apparatus for testing liquid crystal display (LCD) panels, and more particularly to an apparatus with an angle adjusting device.

### BACKGROUND

In mass manufacturing of products such as LCD monitors, the LCD panels thereof should be tested to determine if they are defective or not before they are assembled together with other parts of the monitor.

Referring to FIG. 7, this shows a conventional testing apparatus for testing LCD panels. The apparatus 10 includes a horizontal working table 11, and a carrier 12 obliquely mounted on the working table 11. The carrier 12 has a generally rectangular shape, and is used for supporting LCD panels placed thereon. The carrier 12 may be set to maintain an angle anywhere in the range from 25 to 65 degrees relative to the working table 11. Thus an operator can select a suitable angle for particular LCD panels to be tested.

However, when the apparatus 10 is installed at a production line, the angle between the carrier 12 and the working table 11 is set. This means that the operator cannot readily adjust the carrier 12 during the process of testing an LCD panel. The fixed carrier 12 is liable to cause inconvenience to the operator. If the angle between the carrier 12 and the working table 11 needs to be adjusted, the entire apparatus 10 may need to be re-arranged. This requires time and manpower and increases production costs.

Accordingly, what is needed is an apparatus for testing LCD panels that can overcome the above-described deficiencies.

### SUMMARY

An exemplary apparatus for testing liquid crystal display panels includes an angle adjusting device and a supporting plate mounted on the angle adjusting device for supporting at least one liquid crystal display panel. The angle adjusting device includes a base and a ball-and-socket joint mounted on the base. The ball-and-socket joint includes a rocker with a spherical end, a first connecting rod with a groove and a second connecting rod with a complementary groove. The grooves of the first and second connecting rods cooperatively define a socket for containing the spherical end of the rocker therein. The first connecting rod is movable relative to the second connecting rod so that the spherical end of the rocker is either locked in a desired position or frees to be manually rotated to a desired position.

With this configuration, the angle adjusting device in this apparatus may enables the operator easily and conveniently to adjust the angle and position of the supporting plate during the testing process.

Other advantages and novel features will become more apparent from the following detailed description when taken in conjunction with the accompanying drawings.

### BRIEF DESCRIPTION OF THE DRAWINGS

FIG. 1 is an exploded, isometric view of an apparatus for testing LCD panels according to a first embodiment of the present invention; the apparatus including a supporting plate, and an angle adjusting device with a ball-and-socket joint.

FIG. 2 is an exploded, isometric view of certain parts of the ball-and-socket joint of the angle adjusting device of the apparatus of FIG. 1.

FIG. 3 is an assembled view of the apparatus of FIG. 1.

FIG. 4 is a front plan view of the apparatus of FIG. 3 except for the supporting plate thereof, showing in phantom various positions that the ball-and-socket joint of the angle adjusting device can be rotated to.

FIG. 5 is a right side plan view of the apparatus of FIG. 3 except for the supporting plate thereof, showing in phantom various positions that the ball-and-socket joint of the angle adjusting device can be rotated to.

FIG. 6 is an isometric view of an apparatus for testing LCD panels according to a second embodiment of the present invention.

FIG. 7 is an isometric view of a conventional apparatus for testing LCDs.

### DETAILED DESCRIPTION OF PREFERRED EMBODIMENTS

Reference will now be made to the drawings to describe the present invention in detail.

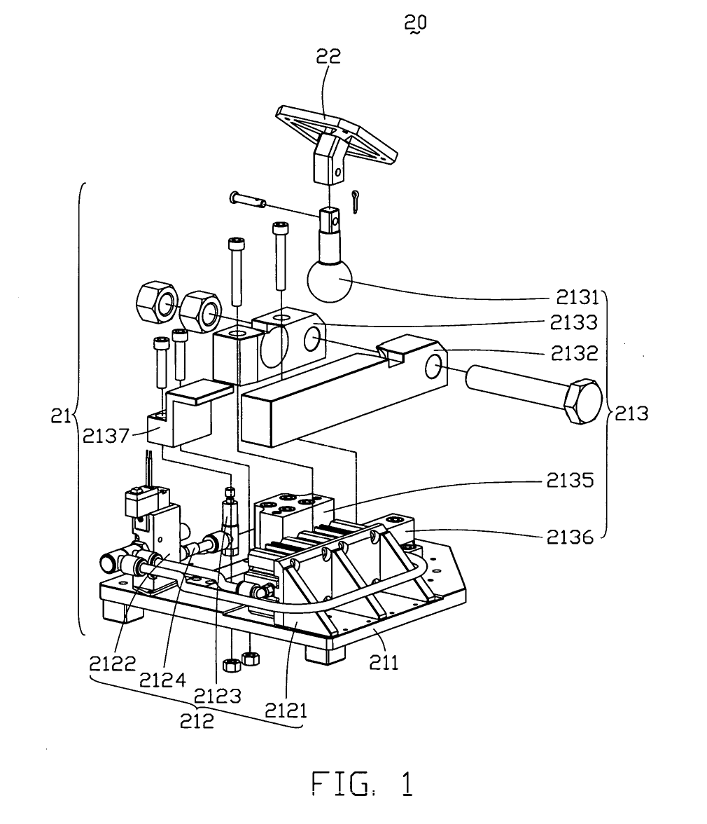

FIG. 1 shows an apparatus for testing LCD panels according to a first embodiment of the present invention. The apparatus 20 includes an angle adjusting device 21, and a supporting plate 22 rotatably mounted on the angle adjusting device 21.

The angle adjusting device 21 includes a base 211, a power controller 212, and a ball-and-socket joint 213. The base 211 is horizontal, the power controller 212 is mounted on the base 211, and the ball-and-socket joint 213 is mounted on the power controller 212.

The power controller 212 is used for providing power to drive the ball-and-socket joint 213 to open and close. The power controller 212 includes an air cylinder 2121, an electromagnetic valve 2122, a pressure regulating valve 2123, and a plurality of air pipes 2124.

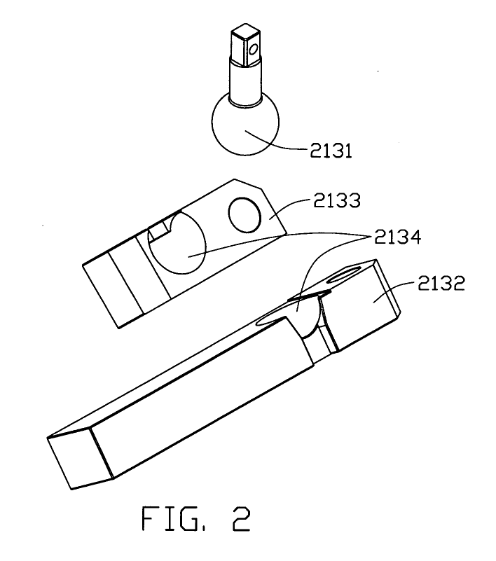

Also referring to FIG. 2, an exploded view of certain parts of the ball-and-socket joint 213 is shown. The ball-and-socket joint 213 includes a rocker 2131 with a spherical end, a first connecting rod 2132, a second connecting rod 2133, a first reinforcement plate 2135, a second reinforcement plate 2136, and a block 2137. The first and second connecting rods 2132 and 2133 each define a socket portion 2134.

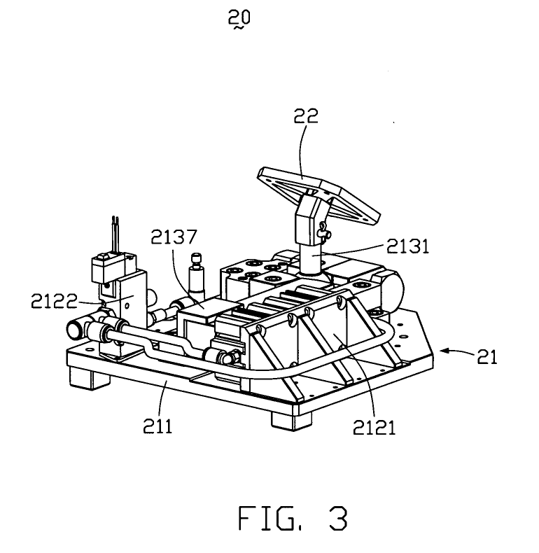

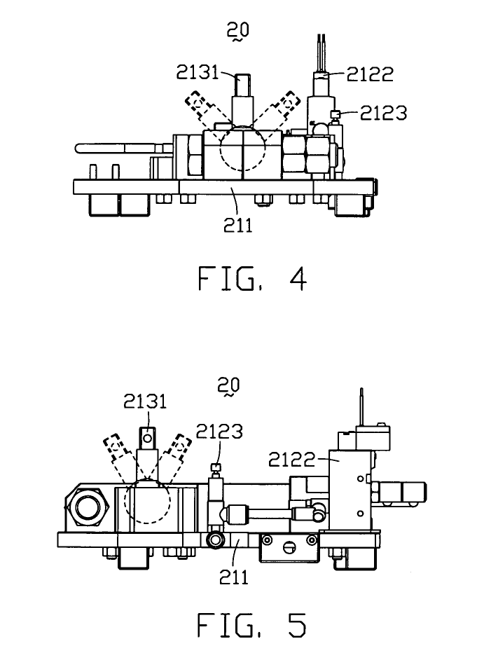

Referring to FIG. 3, when the apparatus 20 is assembled, the first and second connecting rods 2132 and 2133 are mated with each other via a bolt (not labeled), and are thereby fixed on the base 211 parallel to each other. The socket portions 2134 of the first and second connecting rods 2132 and 2133 cooperatively define a socket (not labeled) for receiving the spherical end of the rocker 2131 therein. The first and second reinforcement plates 2135 and 2136 are respectively disposed alongside the first and second connecting rods 2132 and 2133, such that the first and second connecting rods 2132, 2133 are held between the first and second reinforcement plates 2135, 2136. The block 2137 mates with one end of the first connecting rod 2132, for preventing the first connecting rod 2132 from moving vertically.

Also referring to FIGS. 4-5, in operation, the size of the socket gradually increases when the first connecting rod 2132 is gradually moved horizontally away from the second connecting rod 2133. The size of the socket eventually becomes large enough for the spherical end of the rocker 2131 to be released from a locked position in the socket. The rocker 2131 is then able to be freely rotated by an operator. That is, the ball-and-socket joint 213 is in a free state. Once the rocker 2131 is moved to a new desired angle and/or position, the first connecting rod 2132 can be horizontally moved back toward the second connecting rod 2133. The socket gradually decreases in size until the first and second connecting rods 2132, 2133 clasp and lock the spherical end of the rocker 2131 in the new position. That is, the ball-and-socket joint 213 is in a locked state.

The operator may switch the electromagnetic valve 2122 in order to change the air cylinder 2121 from a discharged state to a charged state, or vice-versa. When the air cylinder 2121 is in the discharged state, the first connecting rod 2132 may be easily moved by hand in order to bring the ball-and-socket joint 213 to the free state. Then the operator may easily and conveniently rotate the rocker 2131 to a desired angle and/or position. After that the air cylinder 2121 activated back to the charged state. In this process, the first connecting rod 2132 gradually moves and locks the spherical end of the rocker 2131 in cooperation with the second connecting rod 2133. The ball-and-socket joint 213 is thus returned to the locked state, with the supporting plate 22 fastened to the base 212 at a desired orientation.

In short, the operator may switch the electromagnetic valve 2122 to release or lock the ball-and-socket joint 213 in order to adjust the angle and/or position of the supporting plate 22 anytime during the process of testing LCD panels.

If desired, the supporting plate 22 may further include a cushion (not shown) thereon in order to protect the LCD panels to be tested.

In summary, the apparatus 20 includes an angle adjusting device 21. The angle adjusting device 21 enables the operator to easily and conveniently adjust the angle and/or position of the supporting plate 22 during the testing process.

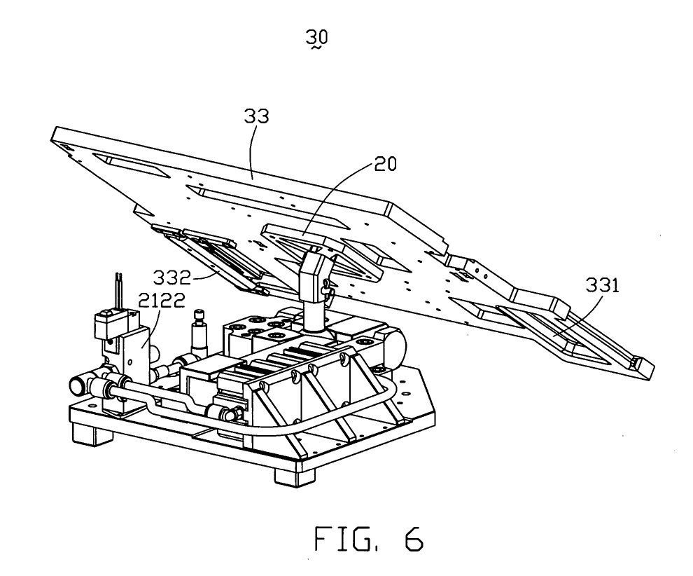

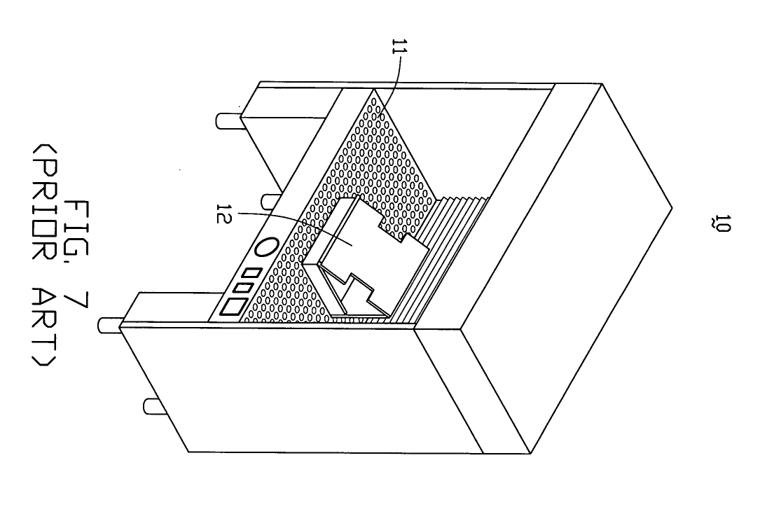

Referring to FIG. 6, this shows an apparatus for testing LCD panels according to a second embodiment of the present invention. The apparatus 30 is similar to the above-described apparatus 20, but further includes an extension plate 33 mounted on the supporting plate 22. The extension plate 33 includes a notch 331, and a switch 332 for controlling the electromagnetic valve 2122. The extension plate 33 may be used for placing a larger sized LCD panel thereon, or for placing several LCD panels thereon at one time. A process for adjusting an angle and/or position of the extension plate 33 of the apparatus 30 is similar to that described above in relation to the supporting plate 22 of the apparatus 20.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An apparatus for testing liquid crystal display panels, comprising:
an angle adjusting device comprising a base and a ball-and-socket joint mounted on the base; the ball-and-socket joint comprising a rocker with a spherical end, a first connecting rod with a groove, and a second connecting rod with a complementary groove, wherein the grooves of the first and second connecting rods cooperatively define a socket for containing the spherical end of the rocker, and the first connecting rod is movable relative to the second connecting rod so that the spherical end of the rocker is either locked in a desired position or free to be manually rotated to a desired position; and
a supporting plate mounted on the angle adjusting device, for supporting at least one liquid crystal display panel.

2. The apparatus as claimed in claim 1, wherein the angle adjusting device further comprises a power controller for providing power to control movement of the first connecting rod relative to the second connecting rod.

3. The apparatus as claimed in claim 2, wherein the power controller further comprises an air cylinder and an electromagnetic valve connected to the cylinder.

4. The apparatus as claimed in claim 1, wherein the angle adjusting device further comprises a block mounted on the base, the block being for preventing the first connecting rod from moving vertically.

5. The apparatus as claimed in claim 1, wherein the supporting plate comprises a cushion for protecting the at least one liquid crystal display panel.

6. The apparatus as claimed in claim 1, further comprising an extension plate mounted on the supporting plate.

7. An apparatus for testing liquid crystal display panels, comprising:
an angle adjusting device including a rocker defining a linear direction therealong, when said rocker is essentially in a vertical direction of a base, with at a lower end a ball rotatably disposed in a socket which is immoveable relative to the ball; and
a supporting plate mounted on an upper end of the angle adjusting device for supporting at least one liquid crystal display panel; wherein
said supporting plate is oblique to the linear direction of the rocker.
